(19) United States
(12) Patent Application Publication
(10) Pub. No.: US 2003/0187666 A1
(43) Pub. Date: Oct. 2, 2003

(54) Techniques for dispensing postage using a communications network

(75) Inventor: J. P. Leon, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Neopost Inc., Hayward, CA (US)

(21) Appl. No.: 10/109,539

(22) Filed: Mar. 26, 2002

(51) Int. Cl. G06G 7/00; G06F 17/00; G06F 17/60

(52) U.S. Cl. 705/1

(57) ABSTRACT

The generation of secure compact indicia without the need for cryptographically generated identifiers such as digital signatures in the indicia. A unique serial number is assigned to each indicium, the serial number is incorporated into the indicium, and additional information is stored. This additional information includes what is referred to as “other required information,” which is information specified to be sufficient to verify the indicium, and is ultimately stored at a different location from the location where the indicium request initiated. Verification occurs by comparing the required indicium content (serial number and other required information) with the previously stored version of the required indicium content.

### CROSS-REFERENCES TO RELATED APPLICATIONS

The following commonly owned copending applications, including any attachments and appendices, are hereby incorporated by reference in their entirety for all purposes:

U.S. patent application Ser. No. 09/902,480, titled “Method and System for Providing Stamps by Kiosk,” by James D. L. Martin, et. al., filed Jul. 9, 2001;

U.S. patent application Ser. No. 09/708,971, entitled “Providing Stamps on Secure Paper Using a Communications Network,” by J. P. Leon, et. al., filed Nov. 7, 2000; and

U.S. patent application Ser. No. 09/708,883, entitled “Techniques for Dispensing Postage Using a Communication Network,” by L. Carlton Brown, Jr, et. al., filed Nov. 7, 2000.

### BACKGROUND OF THE INVENTION

This application relates generally to value dispensing systems and more specifically to techniques for dispensing postage using a communication network.

Traditional postage meters have well-known advantages over using postage stamps, and are widely deployed throughout the business world. A typical postage meter includes a secure tamper-evident housing that contains a print mechanism and postage registers (e.g., ascending and descending registers) whose values represent postal value. While the original postage meters used mechanical registers, more recent generations of meters use electronic registers (non-volatile memory) and operate under the control of a microprocessor or microcontroller. Most of the meters currently in use rely on impact printing by a mechanism that is located within the secure housing.

In 1996, the United States Postal Service (USPS) promulgated initial draft specifications for its Information Based Indicia Program (IBIP). The IBIP program contemplates postal indicia printed by conventional printers (e.g., thermal, inkjet, or laser). An indicium refers to the imprinted designation or a postage mark used on mailpieces denoting evidence of postage payment, and includes human-readable and machine-readable portions. The machine-readable portion was initially specified to be a two-dimensional barcode symbology known as PDF417, but implementations using Data Matrix symbology have been deployed. The indicium content is specified to include a digital signature for security reasons (to preclude forgery).

There are separate specifications for open and closed systems. The specifications have been updated over the last few years; the recent specifications for open and closed systems are:

Information-Based Indicia Program (IBIP) Performance Criteria for Information-Based Indicia and Security Architecture for Open IBI Postage Evidencing Systems (PCIBI-O) (Draft Feb. 23, 2000), and

Information-Based Indicia Program (IBIP) Performance Criteria for Information-Based Indicia and Security Architecture for Closed IBI Postage Metering Systems (PCIBI-C) (Draft Jan. 12, 1999).

These specifications are currently available for download from the USPS website at the following URL:

http://www.usps.com/postagesolutions/programdoc.html

and are herein incorporated by reference in their entirety for all purposes.

An open system is defined as a general purpose computer used for printing information-based indicia, but not dedicated to the printing of those indicia. A closed system is defined as a system whose basic components are dedicated to the production of information-based indicia and related functions, that is, a device dedicated to creating indicia similar to an existing, traditional postage meter. A closed system may be a proprietary device used alone or in conjunction with other closely related, specialized equipment, and includes the indicium print mechanism.

The IBIP program specifies, for open and closed systems, a postal security device (PSD) that manages the secure postage registers and performs the cryptographic operations of creating and verifying digital signatures. This is a tamper-evident hardware component at the user site. In the case of an open system, it is attached to the host personal computer, while in a closed system, it is typically located within the same secure housing as the print mechanism. The closed system meter may be a standalone device or may be operated in communication with a host computer. In order to eliminate the need for secure hardware at the user site, there have been a number of systems where the PSD functions are performed at a server, and the user computer communicates with the server to download digitally signed indicium messages that can be formatted into IBIP-compliant indicia.

An indicium complying generally with the IBIP specifications is validated by verifying the digital signature that is included as part of the indicium. This is done by scanning the machine-readable portion of the indicium, obtaining the public key certificate number from the indicium, obtaining the public key corresponding to the certificate number, using the public key and the other data elements in the indicium to verify the digital signature using the algorithm that is used by the particular digital signature technique (e.g., DSA, RSA, ECDSA).

While the IBIP program provides improved security and enables a new class of applications, one disadvantage is that the machine-readable portion is required to encode 89 bytes of data or more (depending on the digital signature algorithm used). This tends to lead to relatively large indicia, which can be problematical for at least some applications. However, there is a need to maintain security (i.e., to prevent fraudulent activities such as printing a single indicium which is paid for, and duplicating it multiple times without paying for the duplicates, or altering the indicium data contents to appear that more postage has been paid for). The digital signature is normally seen as the key to providing secure indicia, and the fact that the digital signature requires 40 bytes (for DSA or ECDSA) or 128 bytes (for RSA) is accepted as a necessary penalty.

Another factor to be considered is the computational overhead associated with producing digital signatures. If a closed system meter is to be incorporated into a high-speed mailing system (i.e., one that processes a large number mailpieces per hour), generating the digital signature for each mailpiece places a speed penalty on the system or requires a more powerful (and hence more expensive) processor in the PSD.

### BRIEF SUMMARY OF THE INVENTION

In short, the invention contemplates the generation of secure compact indicia without the need for cryptographically generated identifiers such as digital signatures in the indicia. The invention is suitable for generating indicia for a variety of uses, including indicia that are printed on a substrate such as a label or a mailpiece, or indicia that are assembled with an electronic message for such purposes as defining a priority or other services associated with the electronic transmission of the message. If the indicium is to be printed, it will typically include a machine-readable form of the indicium information and a human-readable form of at least some information.

The invention operates by assigning a unique serial number to each indicium, incorporating the serial number into the indicium, and storing additional information. This additional information includes what is referred to as “other required information,” which is information specified to be sufficient to verify the indicium, and is ultimately stored at a different location from the location where the indicium request initiated. The serial number and the other required information are sometimes referred to collectively as the “required indicium content.”

Since the indicium does not contain a digital signature or other cryptographic identifier, verification does not occur by any cryptographic analysis of the indicium. Rather, verification occurs by comparing the required indicium content (serial number and other required information) with the previously stored version of the required indicium content. The invention contemplates storing the required indicium content of each indicium at a central facility, sometimes referred to as the postage vendor system (PVS) or simply as the server.

In a first set of embodiments, the server assigns the serial numbers, stores the required indicium content, and sends the serial numbers and at least some of the other required information to remote devices that are requesting indicia. In a second set of embodiments, the remote devices are closed system meters that have previously been funded with postage credit, and these meters assign the serial numbers themselves. The serial numbers and other required information for the indicia are periodically sent to the server, which stores the required indicium content for each indicium.

More specifically, in the first set of embodiments, the server receives a request for a value indicium from a remote device, and generates a unique serial number that is to be associated with the requested indicium. The serial number is stored at the server, along with the other required information that will be incorporated into the indicium. This other required information will normally include information that was part of the request (e.g., postage value and service class in the case of a postal indicium), and may further include information produced by the server (e.g., a postal register value or a time stamp). The server may store information beyond the required indicium content (e.g., payment information).

At least the server-produced indicium information (which at minimum includes the serial number) is sent to the remote device. The manner in which the information is sent to the remote device is implementation-specific. The remote devices are typically not capable of storing postage value, and thus need to provide payment information for each transaction. Examples of remote devices include a user's personal computer with a web browser, a user's PC with installed application-specific software, and a publicly accessible kiosk that contains a computer and printer within a secure housing, and a mechanism for obtaining payment from customers.

In the second set of embodiments, the meter receives a request for a value indicium (typically from a local source), and generates a unique serial number that is to be associated with the requested indicium. The serial number is stored in the meter, along with other information that will be incorporated into the indicium. This other required information will normally include information that was part of the request (e.g., postage value and service class in the case of a postal indicium), and may further include information stored in the meter (e.g., a postal register value or a time stamp). The meter according to this second set of embodiments typically generates serial numbers and assembles other required information without communicating with the server. Rather, the meter typically generates serial numbers for a plurality of indicia, after which the meter sends the required indicium content for the plurality of indicia to the server.

In both sets of embodiments, the verification of an indicium is accomplished by determining the serial number (and possibly other information) from the indicium (e.g., by scanning), and sending a first message containing at least the serial number to the server. The server accesses the indicium information that it had stored for past indicia, determines the other required information associated with the serial number, and sends a second message, which is used to verify the indicium. Fundamentally, the indicium is considered valid if the other required information in the indicium agrees with the other required information that is stored at the server for the same serial number. The actual comparison of the other required information may be done entirely by the entity seeking to verify the indicium (the “verifying entity”), entirely by the server, or partially by both.

In a first implementation, the comparison between the stored information and the information extracted from the indicium is performed entirely by the verifying entity. In this implementation, the first message need only include the serial number, the second message includes all the other required information that had been stored on the server, and the other required information is extracted from the second message and compared to the other required information in the indicium. If the two sets of information agree, the indicium is considered valid.

In a second implementation, the comparison between the stored information and the information extracted from the indicium is performed entirely by the server. In this implementation, the first message needs to include the serial number and the other required information, and the server compares the other required information in the first message with the other required information that is stored for that serial number. The second message need only specify valid or invalid.

In both these implementations, the second message is preferably cryptographically signed by the server, and the verifying entity also cryptographically verifies the second message. The verifying entity may cryptographically sign the first message, and the server would only send the second message after cryptographically verifying the first message.

A further understanding of the nature and advantages of the present invention may be realized by reference to the remaining portions of the specification and the drawings.

### BRIEF DESCRIPTION OF THE DRAWINGS

FIG. 1 is a simplified block diagram of a distributed computer network that may incorporate an embodiment of the present invention;

FIG. 2 is a simplified block diagram of a computer system that may be used to implement one or more of the devices in the distributed computer network;

FIG. 3 is a simplified block diagram of a kiosk that may be used in the distributed computer network;

FIG. 4 is a simplified block diagram of a closed system meter that may be used in the distributed computer network;

FIGS. 5A and 5B show examples of printed stamps suitable for use with embodiments of the present invention;

FIG. 6 is an expanded block diagram of PVS according to an embodiment of the present invention;

FIG. 7 is a flow chart showing the process of a user at a computer or kiosk obtaining a stamp in an embodiment of the present invention;

FIG. 8 is a flow chart showing the process of a meter generating a stamp in an embodiment of the present invention; and

FIGS. 9A and 9B are flow charts showing the process of an entity in the field verifying an indicium in two embodiments of the present invention.

### DESCRIPTION OF THE SPECIFIC EMBODIMENTS

Introduction and System Hardware Overview

The basic functionality of the invention is to allow a variety of value metering transactions to take place, with postage metering being the specific embodiment. While reference will be made to a postal service, it should be understood that the techniques may find utility with other carriers. The invention provides for the creation of secure value indicia, that is, indicia that can be verified to ascertain that the value indicated by the indicium has actually been paid to an authorized vendor (e.g., Neopost Inc.), and that the indicia have not been duplicated or tampered with. The indicia are electronic constructs, which in the specific embodiments are printed on a substrate such as a label or a mailpiece. It should be realized that the indicia may be assembled with an electronic message for such purposes as defining a priority or other services associated with the electronic transmission of the message. If an indicium is to be printed, it will typically include a machine-readable form of the indicium information and a human-readable form of at least some information.

According to an embodiment of the present invention, the indicia are generally along the lines specified by the IBIP specifications published by the United States Postal Service (USPS), with one significant exception. While the IBIP specifications require that each indicium include a digital signature, the present invention provides indicia without digital signatures while maintaining substantially the same ability to verify indicia as is provided by having digital signatures in the indicia.

As will be described in detail below, the security is provided by generating a unique serial number (e.g., a 64-bit number) for each indicium, storing and managing these serial numbers, and defining a number of transactions for verifying a given indicium using its serial number.

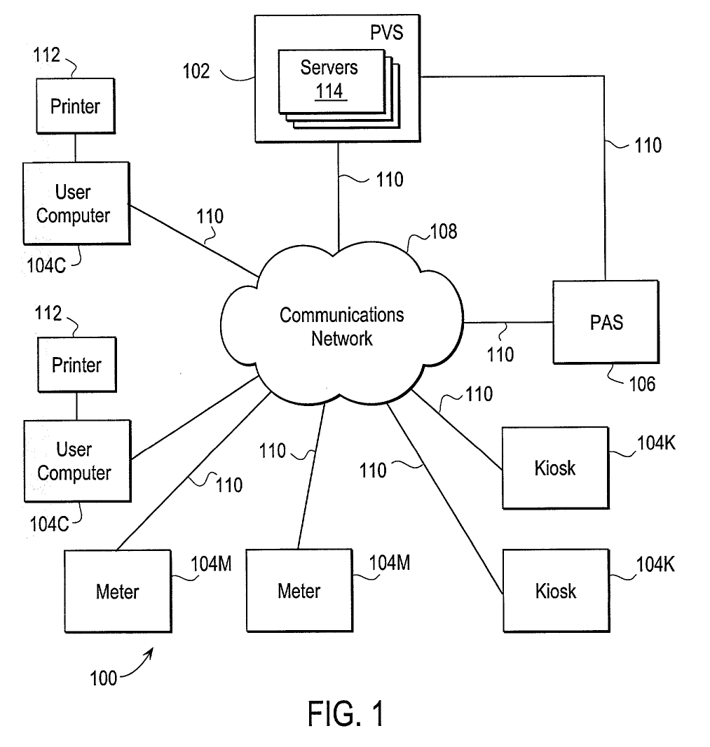

FIG. 1 is a simplified block diagram of a distributed computer network 100 that may incorporate an embodiment of the present invention. Computer network 100 includes at least one postage vendor system (PVS) 102 in communication with one or user systems, which may include one or more user computers 104C (typically, but not necessarily PCs), one or more postage dispensing kiosks 104K, and one or more closed system meters 104M, and a postal authority system (PAS) 106 over a communications network 108 via a plurality of communication links 110. The user computers are shown as having separate printers 112. Much of the discussion will be in terms of transactions between PVS 102 and the user systems, which from the point of view of the PVS are remote devices, and the user systems will sometimes be referred to as remote devices 104.

PVS 102 may itself comprise multiple interconnected computer and server systems 114 and communication links, as will be described below. PVS 102 may be configured to receive postage requests from remote devices 104, validate the postage requests, generate information for printing indicia in response to the postage requests, perform security functions related to the postage transactions, manage funds related to the postage transactions, communicate the information for printing the indicia to the requesting remote devices 104, maintain and manage user accounts, and several other functions. These functions are generally performed by software code modules executed by PVS 102. However, it should be apparent that these functions may be also performed by software modules or hardware modules of PVS 102, or combinations thereof.

Communications network 108 provides a mechanism for allowing the various components of distributed network 100 to communicate and exchange information with each other. Communications network 108 may itself comprise many interconnected computer systems and communication links. Communication links 110 may be hardwire links, optical links, satellite or other wireless communication links, wave propagation links, or any other mechanisms for communication of information. While communications network 108 is the Internet in one embodiment, communications network 108 may be any suitable computer network.

Postal authority system (PAS) 106 may comprise one or more computer systems managed by a postal authority authorized to regulate and control postal matters. Examples of postal authorities include the USPS, France's La Poste, the United Kingdom's Royal Mail, and others. In most instances, the postal authority is a governmental or quasi-governmental agency authorized to oversee postal matters. PAS 106 may be coupled to PVS 102 via communications network 108 or directly via some other communication link 110. The information exchanged between PVS 102 and PAS 106 may include finance information, information required by the postal authority for audit purposes, status information, security information, and other like information. The information required by the postal authority for audit purposes may include information identifying the postage buyers, the postage value and amount purchased by the buyers, and other information. PVS 102 may be configured to send information to PAS 106 on a periodic basis using batch processing, or upon the occurrence of certain events. PVS 102 may also be configured to purchase postage from PAS 106.

As is well known, in the United States, all meter indicia reflect the fact that a customer has paid an authorized postage vendor, and in the case of the various remote devices shown in FIG. 1, the payment methodology differs from device to device. For user computers 104C and kiosks 104K, the customer pays for postage at the time of requesting one or more indicia. In the case of meters 104M, the customer pays for postage in advance, postage credit is stored in the meter's accounting registers, and the registers are adjusted to reflect indicia generated.

Depending on the remote device, the indicia may be printed on plain paper or paper incorporating various security features such as a watermark, microprint, a fluorescent stripe, serrated edges, taggants, and pre-printed label serial numbers at the level of individual label, label sheet, or label roll.

Further, as mentioned briefly above, aspects of the present invention use unique indicium serial numbers. The generation, distribution, and long-term storage of the indicium serial numbers is performed by PVS 102 for the cases where the remote device is one of user computers 104C or one of kiosks 104K. However, the generation of the indicium serial numbers for indicia generated by meters 104M is carried out by the meters themselves, which periodically upload the already-generated serial numbers to PVS 102 for long-term storage.

Computer Configurations

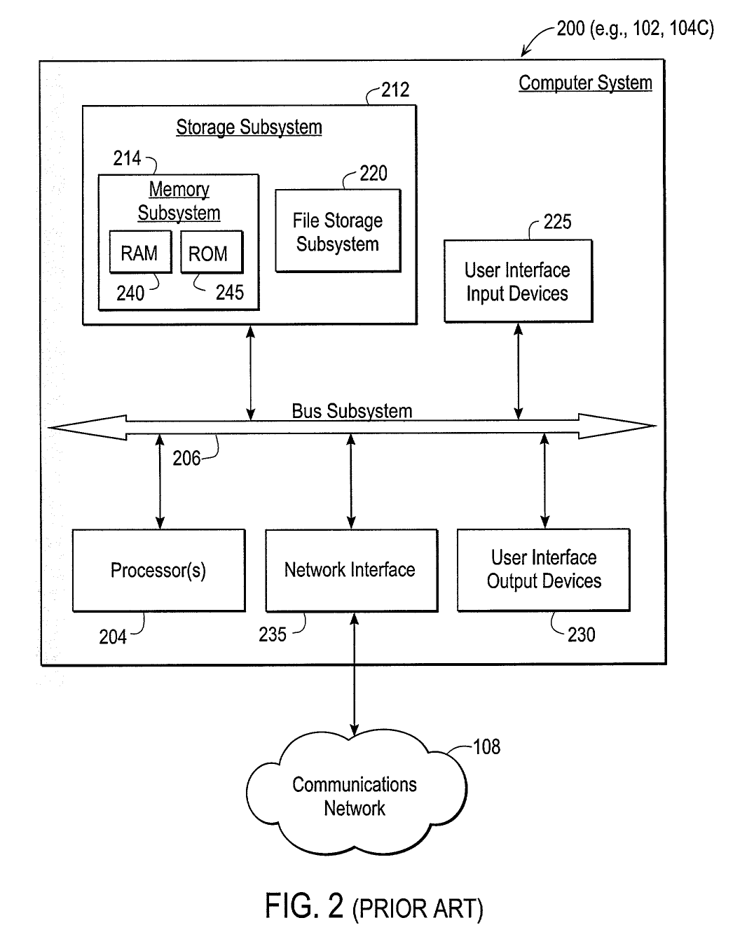

FIG. 2 is a simplified block diagram of an exemplary computer system 200 suitable for use with the invention. Since the figure is drawn at a high level, it is labeled “Prior Art.” When operating in the context of embodiments of the invention, such a computer system is not prior art. Computer system 200 may function as one of the user computers 104C, as PVS 102 or as one of the computer systems which make up PVS 102, as PAS 106, or other like system. Computer system 200 typically includes at least one processor 204, which communicates with a number of peripheral devices via a bus subsystem 206. These peripheral devices typically include a storage subsystem 212, comprising a memory subsystem 214 and a file storage subsystem 220, user interface input devices 225, user interface output devices 230, and a network interface subsystem 235.

The input and output devices allow user interaction with computer system 200. It should be apparent that the user may be a human user, a device, a process, another computer, and the like. Network interface subsystem 235 provides an interface to outside networks, including an interface to communications network 108, and is coupled via communications network 108 to corresponding interface devices in other computer systems. The network interface may include, for example, a modem, an Integrated Digital Services Network (ISDN) device, an Asynchronous Transfer Mode (ATM) device, a Direct Subscriber Line (DSL) device, a fiber optic device, an Ethernet card, a cable TV device, or a wireless device.

User interface input devices 225 may include a keyboard, pointing devices such as a mouse, trackball, touchpad, or graphics tablet, a scanner, a barcode scanner for scanning article barcodes, a touchscreen incorporated into the display, audio input devices such as voice recognition systems, microphones, and other types of input devices. In general, use of the term “input device” is intended to include all possible types of devices and ways to input information into computer system 200 or onto communications network 108.

User interface output devices 230 may include a display subsystem, a printer, a fax machine, or non-visual displays such as audio output devices. The display subsystem may be a cathode ray tube (CRT), a flat-panel device such as a liquid crystal display (LCD), or a projection device. The display subsystem may also provide non-visual display such as via audio output devices. In general, use of the term “output device” is intended to include all possible types of devices and ways to output information from computer system 200 to a user or to another machine or computer system.

Storage subsystem 212 stores the basic programming and data constructs that provide the functionality of the computer system. For example, the various program modules and databases implementing the functionality of the present invention may be stored in storage subsystem 212 of PVS 102. These software modules are generally executed by processor(s) 204. In a distributed environment, the software modules may be stored on a plurality of computer systems and executed by processors of the plurality of computer systems. Storage subsystem 212 also provides a repository for storing the various databases storing information according to the present invention. Storage subsystem 212 typically comprises memory subsystem 214 and file storage subsystem 220.

Memory subsystem 214 typically includes a number of memories including a main random access memory (RAM) 240 for storage of instructions and data during program execution and a read only memory (ROM) 245 in which fixed instructions are stored. File storage subsystem 220 provides persistent (non-volatile) storage for program and data files, and may include a hard disk drive, a floppy disk drive along with associated removable media, a Compact Digital Read Only Memory (CD-ROM) drive, an optical drive, removable media cartridges, and other like storage media. One or more of the drives may be located at remote locations on other connected computers at another site on communications network 108.

Bus subsystem 206 provides a mechanism for letting the various components and subsystems of computer system 200 communicate with each other as intended. The various subsystems and components of computer system 200 need not be at the same physical location but may be distributed at various locations within distributed network 100. Although bus subsystem 206 is shown schematically as a single bus, but embodiments of the bus subsystem may utilize multiple buses.

Computer system 200 itself can be of varying types including a personal computer, a portable computer, a workstation, a computer terminal, a network computer, a mainframe, or any other data processing system. Due to the ever-changing nature of computers and networks, the description of computer system 200 depicted in FIG. 2 is intended only as a specific example for purposes of illustrating a representative configuration. Many other configurations of a computer system are possible having more or fewer components than the computer system depicted in FIG. 2. Client computer systems and server computer systems generally have the same configuration as shown in FIG. 2, with the server systems generally having more storage capacity and computing power than the client systems.

Remote Device Configurations

User Computer

User computers 104C allow users of the present invention, for example, postage consumers, to interact with and buy postage from PVS 102. These users may include one or more human beings interacting with a user computer 104C, one or more processes executing on user computer 104C or systems coupled to user computers 104C, devices coupled to user computer 104C, or other entities capable of interacting with PVS 102. Users may use user computers 104C to configure requests to purchase postage from PVS 102. These user purchase requests are then communicated from user computers 104C to PVS 102 via communication network 108. In response to the user requests, user computers 104C may receive information for printing one or more indicia from PVS 102. A user may then use user computer 104C to print the indicia using printer 112. The indicia may be printed on labels, on paper, on the mailpieces themselves, or on other like media. In alternative embodiments, a user using user computer 104C may store the information for printing indicia received from PVS 102 on a storage medium, such as a computer disk, for subsequent printing or other use of the indicia.

Users may also use user computers 104C to perform other activities such as browse web-pages stored by PVS 102, register as users of services provided by PVS 102, provide financial and credit information for consummating commercial transactions with PVS 102, review status of user accounts if such accounts are maintained by PVS 102, review postage purchase history, access help or customer services provided by PVS 102, and to perform other like activities. Accordingly, in a client-server environment, user computer 104C typically operates as a client requesting information from PVS 102 which operates as a server which performs processing in response to the client request and provides the requested information to the client systems. It should be however apparent that a particular user computer 104C may act both as a client or a server depending on whether the user computer is requesting or providing information.

As stated above, a user may use user computer 104C to browse or interact with web pages provided by PVS 102. These web pages may be stored by one or more web servers in PVS 102 and may be accessed by users of user computer 104C via a browser program executing on user computer 104C. In the Internet and World Wide Web (the “Web”) environment, the web pages may be written in a markup language such as Hypertext Markup Language (HTML) and may incorporate any combination of text, graphics, audio and video content, software programs, and other data. Web pages may also contain hypertext links to other web pages.

Kiosk

Simply put, kiosks 104K are dedicated computer systems in secure housings for providing the postage purchasing and printing functionality discussed above. For example, users may use kiosks 104K to configure requests to purchase postage from PVS 102. These user purchase requests are then communicated from kiosks 104K to PVS 102 via communications network 108. In response to the user requests, kiosk 104K may receive information for printing indicia (or a single indicium) from PVS 102. A user may then use kiosk 104K to print the indicia using a printer device, where the printer device is part of the kiosk 104K.

The kiosk is typically located in a place readily accessible to the public, for example, a store, supermarket, gas station, restaurant, a post office, on the side of a building, a bank, government building, airport, bus station, subway station, train station, apartment complex, resort, hotel, motel, and so forth. The kiosk neither accepts nor dispenses cash, but uses an electronic form of payment using, for example, a credit card, club card, ATM card, or smart card. And while one of the primary purposes of the kiosk of the preferred embodiment is to dispense postage stamps, other uses, such as electronic commerce, sending/reading email, banking, buying tickets, paying bills, searching the Internet, video teleconferencing, viewing advertisements, movie clips, or just browsing the Web, may be done by the user.

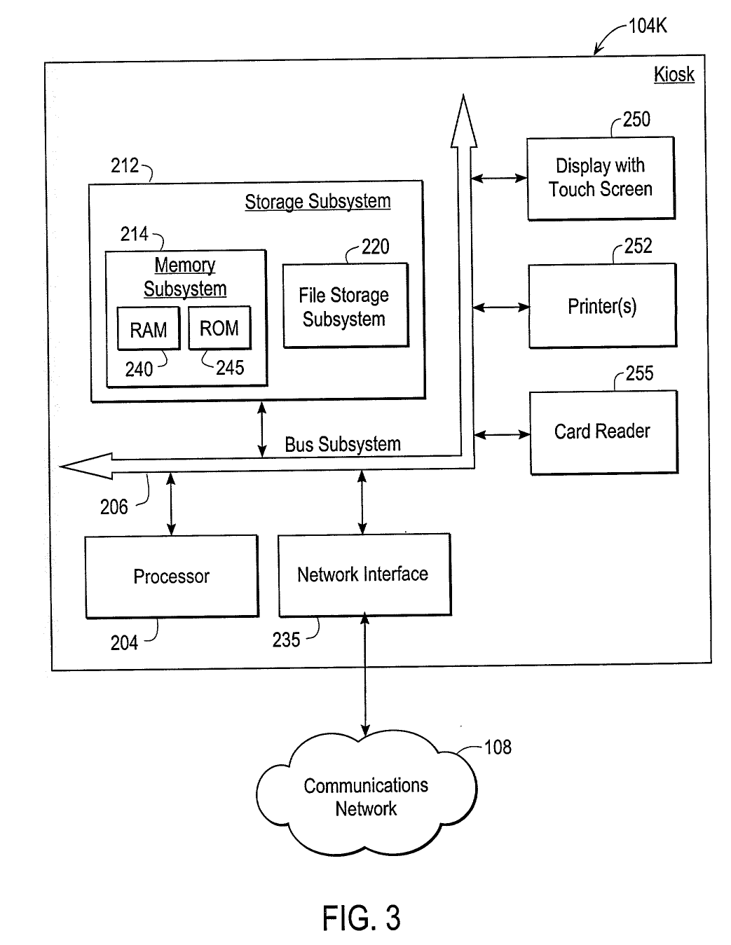

FIG. 3 is a simplified block diagram of kiosk 104K suitable for use with the present invention. The kiosk may be based on a PC such as shown in FIG. 2, and contains many of the corresponding elements (processor 204, bus subsystem 206, storage subsystem 212 including memory and file storage subsystems 214 and 220, and network interface 235), which are shown with corresponding reference numerals. In accordance with its dedicated use as a kiosk, the peripherals are specialized for that purpose, and include an integrated display and touch screen 250, an indicium printer 252, and a credit card reader 255. These are normally built in to the kiosk housing, which may be recessed into a wall so that only a front panel is exposed. The memory and file storage subsystems optionally provide a repository for storing the various databases that maintain information regarding kiosk transactions. In an alternative embodiment the display may be a LCD or CRT display with a separate keypad included as part of the single housing.

Closed System Meter

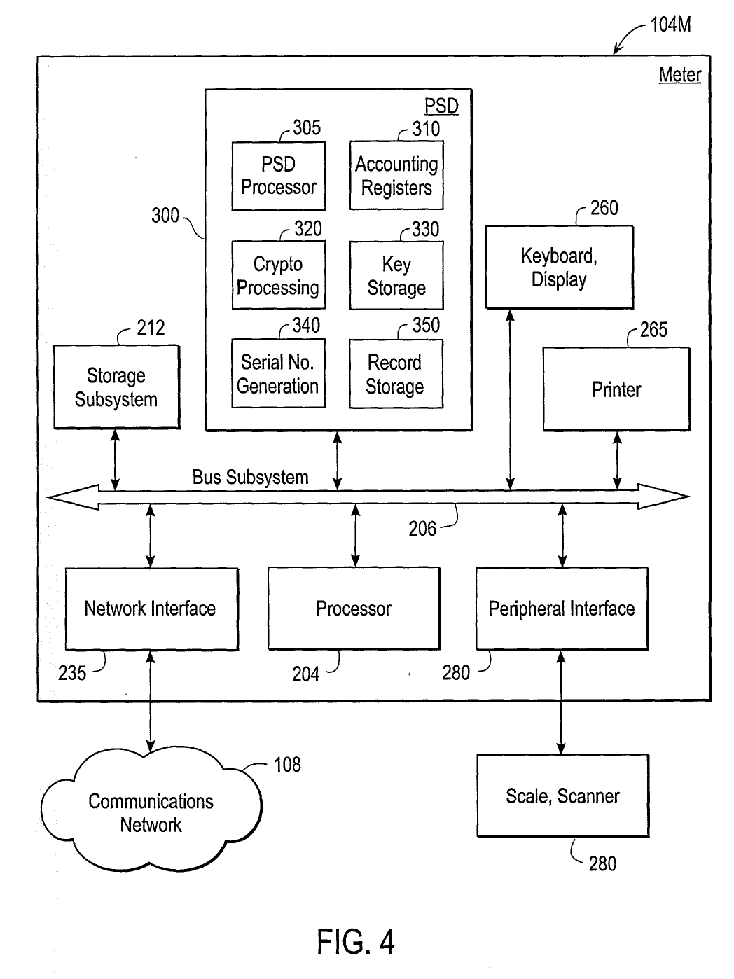

FIG. 4 is a simplified block diagram of an exemplary closed system meter 104M that may be used to implement one or more of the meters in distributed computer network 100. The meter is a dedicated computer system and as such contains many of the corresponding elements (processor 204, bus subsystem 206, storage subsystem 212 including memory and file storage subsystems, and network interface 235), which are shown with corresponding reference numerals. In accordance with its dedicated use as a meter, the other components tend to be specialized for that purpose, and include a keyboard and display indicated as a single block 260, an indicium printer 265, and a peripheral interface 270. The keyboard and display are typically integrated into the meter housing, and are typically implemented as separate devices, namely a keyboard with a numeric keypad and a number of special-purpose keys, and a relatively small LCD. Alternatively the keyboard and display could be implemented as a single touchscreen.

Peripheral interface 270 is configured to communicate with external devices, denoted as a single block 280. These include such devices as a scale or a scanner for acquiring mailpiece information, a mailing machine base, or another computer, such as an accounting computer. Network interface 235 may function to connect the meter to one or more other computers on a local area network.

One component that is unique to the meter's functionality is a postal security device (PSD) 300 that includes a processor 305 to performs functions along the lines of the PSD specified by the USPS's IBIP specifications. Part of the functionality, which is actually a more general postage meter requirement, is that the meter store accounting registers (e.g., ascending register (AR), descending register (DR), maximum and minimum postage values), a unique meter number, and originating address. This is shown as an accounting registers block 310. The IBIP specifies the meter number to include, in a specific format, the PSD manufacturer ID assigned by the USPS, the PSD model ID, and the PSD serial number assigned by the PSD manufacturer.

Further in accordance with the IBIP PSD requirements, the PSD also includes cryptographic software 320 to enable processor 305 to perform cryptographic processing, including generating a key pair and generating and verifying digital signatures in accordance with the algorithm that is used by the particular digital signature technique (e.g., DSA, RSA, ECDSA). The current specific embodiment uses DSA, but ECDSA may be preferred. In support of the digital signature functionality, the PSD also stores the PSD X.509 certificate serial number, the PSD private key, and the IBIP common parameters that are used for the digital signature generation and verification. This is shown as a key storage block 330. It was noted above that the present invention contemplates creating indicia without digital signatures, but digital signatures are required to support device audit and postage value download transactions, and may be used in support of some aspects of the invention..

PSD 300 includes two additional elements that are used to support the present invention as applied to meters: software 340 to support the generation of unique indicium serial numbers, and non-volatile storage 350 for indicium transaction records. As will be discussed below, the indicium transaction records are periodically sent to PVS 102 over communications network 108 or by some other authorized means.

Although a single processor is capable of performing all the PSD functions discussed above, cryptographic processing and serial number generation could be performed by separate processors or special purpose hardware. It is also possible that transaction records could be stored in the meter but outside the PSD. As mentioned above, the meter periodically sends the serial numbers and other required information to PVS 102. This could occur as a two-step process. For example, the meter could store up to a certain number of indicium transaction records inside the PSD, and then send them for temporary storage in the meter's storage subsystem 212. Indeed, the records could be stored in other locations, such as on another computer in communication with the meter.

Representative Indicia

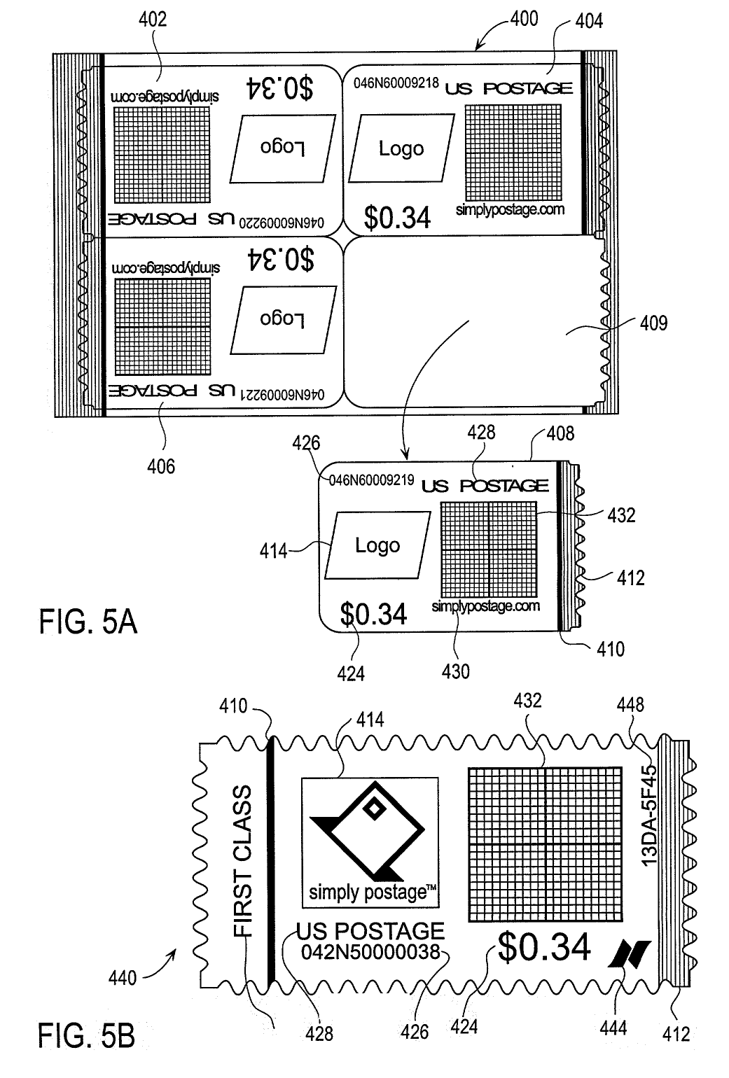

FIGS. 5A and 5B show specific stamp designs that can be used in connection with embodiments of the invention. The stamps in FIG. 5A were designed specifically for use in kiosks 104K while the stamp in FIG. 5B was designed for use in connection with user computers 104C having a general purpose printer such as a laser printer. However, either of these designs would be suitable for any of the remote devices, including meters 104M. The present invention is not limited to any particular stamp design.

FIG. 5A shows an example of four printed stamps on a label sheet 400, which includes stamps 402, 404, 406, and 408, where stamp 408 is shown as having been removed from location 409. Stamp 408, for example, incorporates security features including a microprint strip 410 and a fluorescence strip 412 having serrated edges. The stamp also has human-readable features including a logo 414 (e.g., the U.S. Post Office Eagle), the postage amount 424 (e.g., $0.34), the meter number. 426 (e.g., 046N0009219), a text legend 428 stating “US POSTAGE,” and a company Web address 430 (e.g., simplypostage.com). In the user computer and kiosk embodiments, the meter number refers to a specific resource in PVS 102 that participated in generating the information for printing the indicium. It is noted in passing that the two stamps on the left side are inverted with respect to the two on the right side. This allows the fluorescent ink to be printed along the outside edges of the label sheet while having the printed stamps all identical.

The stamp also includes a machine-readable portion 432 (shown schematically as a grid), which includes indicium information (but does not contain a digital signature). The machine-readable portion is a two-dimensional symbology such as a stacked barcode (e.g., PDF417) or a matrix symbology (e.g., Data Matrix, currently preferred). The stamps are printed on a label sheet that initially includes microprint strip 410, fluorescent strip 412, and logo 414. The label sheet is stored inside the kiosk and is fed to the printer in response to a request to print postal indicia. After the request for postage is sent from the kiosk (or user computer) to the PVS and the PVS sends a response having the four indicia, the kiosk or user computer printer prints the four stamps on the label sheet 400 and outputs the printed stamps to the user (via a printer slot on the kiosk).

FIG. 5B shows another example of a printed stamp 440, which includes elements corresponding to those elements on the stamps on label sheet 400, and corresponding reference numerals are used. The human-readable portion includes: the postage amount, e.g., “$0.34;” the mail class, e.g., “first class;” and the meter number, e.g., “042N50000038.” Also shown in this stamp is an additional logo 444 and a pre-printed label serial number 448, e.g., “13DA-5F45.” The pre-printed label serial number is an additional security feature that can be used in connection with label sheets that are distributed to consumers as described in the above-referenced U.S. patent application Ser. No. 09/708,971. The feature of the pre-printed serial number is different from the indicium serial number that is part of the present invention, and can augment the security of the indicia.

PVS Structure and Organization

PVS Structure

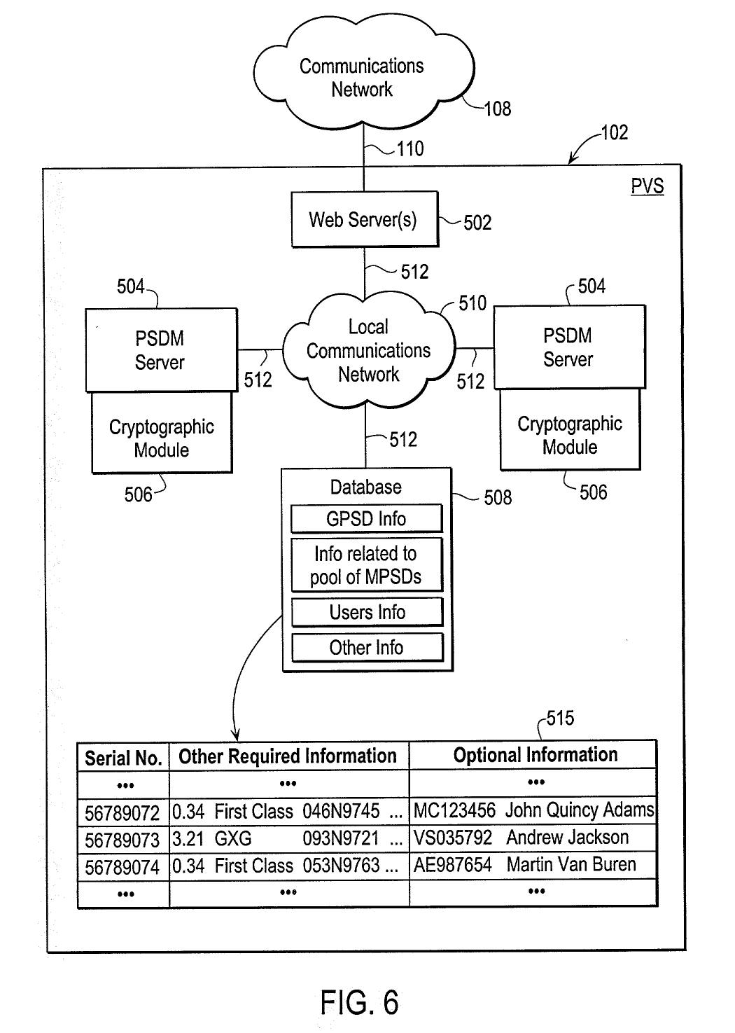

FIG. 6 is an expanded block diagram of PVS 102 according to an embodiment of the present invention. As shown in FIG. 6, PVS 102 may comprise one or more web servers 502, one or more postal security device module (PSDM) servers 504 (each with one or more associated cryptographic modules 506), and a database 508 coupled to a local communications network 510 via a plurality of communication links 512. Local communications network 510 provides a mechanism for allowing the various components of PVS 102 to communicate and exchange information with each other. Local communications network 510 may itself comprise many interconnected computer systems and communication links. Communication links 512 may be hardwire links, optical links, satellite or other wireless communication links, wave propagation links, or any other mechanisms for communication of information. PSDM servers 504 are designed to operate in a clustered environment to allow for expandability, and in one implementation, PSDM servers 504 and web server 502 communicate using a DCOM (Microsoft's Distributed Component Object Model) interface.

Web server(s) 502 may host the postage vendor's web site and store web pages provided by the postage vendor. Web server 502 is responsible for receiving URL requests from requesting entities (in this case user computers 104C and kiosks 104K), and for forwarding web pages corresponding to the URL requests to the requesting entity. As previously stated, these web pages allow a user to interact with PVS 102, e.g. to configure a request to purchase postage from PVS 102. When the requesting entity requests communication with PVS 102, the web server may be configured to establish a communication link between the requesting entity and PVS 102. For example, web server 502 may establish a secure Internet socket link. e.g., a SSL 2.0 link, between PVS 102 and the requesting entity, and may also be configured to control the downloading of printer control programs from PVS 102 to the requesting entities.

Each PSDM server 504 is responsible for generating the indicium or indicia. Each cryptographic module 506 performs cryptographic functions, and stores various keys for performing security-critical functions such as digital signature generation, hashing, and encryption. In one implementation, cryptographic module 506 is an nCipher nFast/CA module which is validated to FIPS 140-1 Level 3 security.

In general, functions performed by PSDM servers 504 include functions performed by a postal security device (PSD) as described in the IBIP specifications published by the USPS. For example, functions performed by PSDM servers 504 include initialization and creation of PSD resources, digital signature generation (although not for indicia in accordance with embodiments of the present invention), management of funds related to the postage dispensed by PVS 102, generation of information for printing the indicia, key handling, and other functions.

PSDM servers 504 use PSD resources to generate information for printing indicia and to track monetary amounts related to the postage dispensed by PVS 102. A PSD resource is a software construct that has attributes of a PSD, including a unique PSD identifier (e.g., a four-byte identifier), a descending register (DR) value (e.g., a four-byte value), an ascending register (AR) value (e.g., a five-byte value), and a control code (e.g., a 20-byte value). The PSD identifier uniquely identifies each PSD resource, the ascending register (AR) value represents the total monetary value of all indicia ever produced by the PSD during its life cycle, and the descending register (DR) value indicates the available funds assigned to the PSD resource which may be used to dispense postage. The control code is a secure hash of the AR and DR values. By using a plurality of PSD resources, multiple PSDM servers 504 can run concurrently, producing indicia in parallel without the bottleneck of sharing a single PSD resource.

In one implementation of PVS 102, monetary amounts related to the postage dispensed by PVS 102 are tracked using a global PSD (GPSD) resource and a pool of PSD resources referred to as mini-PSDs (or MPSDs) stored by PVS 102. For example, eight MPSD resources may be used by a single cryptographic module 506 associated with PSDM server 504 to concurrently generate information for printing indicia. The sum of the AR value and the DR value of the GPSD resource represents the total amount of postage bought from the postal authority, for example, from the USPS, by the postage vendor provider of PVS 102. The sum totals of the AR and DR values of the MPSD resources matches the AR and DR values of the GPSD resource. Information related to the GPSD resource and MPSD resources may be stored in database 508.

Each MPSD resource may be assigned a unique serial number by the postage vendor, and the number assigned to a particular MPSD may be included in the information for printing an indicium generated by the particular MPSD and printed as part of the indicium. For example, the number “046N60009219” (reference 426 in FIG. 5A) uniquely identifies the MPSD resource that was used for generating the information for printing the indicium depicted in FIG. 5A. This MPSD serial number is like a meter number and may be used to track the MPSD resource responsible for generating information for printing the indicium.

PVS Database and Indicia Serial Number

As discussed above, each PSD in one of meters 104M and each MPSD resource is assigned a unique identifier, typically following the IBIP format for the PSD identifier. It is intended that the term “meter number” or “device ID” refer to the meter number for physical PSDs in closed system meters and the identifier for the MPSD resources.

Database 508 acts as a repository for storing information related to the postage dispensing process. For example, database 508 may store information related to the PSD resources (both GPSD and MPSDs), information used for generation of indicia, and other like information. Database 508 may also store the postal license number assigned to PVS 102 by the postal authority. Other information related to the dispensing of postage may also be stored by database 508. The term “database” as used in this application may refer to a single database or to a plurality of databases coupled to local communications network 510. Further, database 508 may be a relational database, an object-oriented database, a flat file, or any other way of storing information. In one implementation, database 508 is coupled to web server 502 and to PSDM server 504 via an ODBC interface.

FIG. 6 further shows a conceptual detail view 515 of database 508 to illustrate the type of information that is stored to support verification of the indicia generated according to embodiments of the present invention. The drawing is at a conceptual level as if the database were a flat file with one record that contained all the relevant information about an indicium. As is well known in the art, database information may be stored in a variety of ways; what is significant is the ability to retrieve the relevant information in response to a query containing specific conditions, such as “find all indicia generated by a particular meter on a particular date.”

As shown, the database stores information for each indicium. This preferably includes records for indicia that the PVS generates in response to indicium requests, and records that are uploaded by closed system meters. This information includes a unique serial number for each indicium, additional information that is present in the indicia and can be used later to verify indicia (referred to as “other required information”), possible other indicium elements that are not required for verification, and other information such as payment or customer information. The serial number and the other required information are sometimes referred to as the required indicium content, and will normally be encoded in the machine-readable portion of the indicium. The required indicium content will normally coincide with the content required by the postal authority, since the postal authority requirements are typically with a view of providing enough information to verify indicia in the field. However, there may be instances where the postage vendor desires to have additional information in the indicium and obtains permission from the postal authority.

In the specific illustrated example, the other required information includes at least the indicium amount, the class of service, and the meter number. The optional information includes credit card and customer information. The serial numbers are shown schematically as being consecutive integers, which is the conceptually simplest approach. However, any regime that ensures uniqueness can be used. In point of fact, in the specific system being described, different PSDM servers are assigning the serial numbers concurrently and closed system meters are assigning serial numbers for their indicia during intervals where they are not in communication with PVS 102. One way to ensure uniqueness is to have each PSD or PSD resource that generates serial numbers include as part of the serial number a portion of the PSD's meter number. This is automatically taken care of so long as the PSD's meter number is part of the “other required information.” Thus it suffices that each PSD or PSD resource is able to generate a number (to be used as part of the serial number) that is unique for each indicium generated by that PSD.

The information included in the indicium will typically be specified to include some or all of the following: indicium version number, meter number (PSD manufacturer, model, and serial number), ascending register value, postage amount, date of mailing, licensing ZIP code, software ID, descending register value, and mail class or category. As discussed above, the meter number is sometimes referred to as the device ID or the PSD resource identifier. (In the IBIP specification, where the indicium includes a digital signature, the indicium is also required to include the digital signature algorithm ID and the public key certificate serial number to facilitate verification of the digital signature.)

As mentioned, it is an aspect of the invention that each indicium have a unique serial number. However, the term “serial number” should be taken to include any combination of information that is enough to uniquely identify a given indicium. Thus, as mentioned above, any quantity that is unique for a given PSD or PSD resource, when combined with that PSD or PSD resource's own unique identifier, can guarantee that the combined entity is unique for each indicium. For example, a time stamp combined with the date will be different for every indicium generated by a given PSD. Similarly, the ascending register value will in general be different for every indicium generated by a given PSD.

As a matter of implementation, it is generally more convenient to assign indicium serial numbers in a numerical or other predictable sequence that does not repeat over the permitted range. Where serial numbers are generated by different PSDs concurrently, a unique meter number should be included as part of the serial number. Alternatively and generally not preferred, discrete ranges of indicium serial numbers could be allocated to different PSDs. Since the indicium will, in most instances, include the meter number, it suffices to let each PSD or PSD resource generate its own unique indicium identifiers and combine them with the meter number to define the unique serial number.

Basic Transactions

Indicium Generation for User Computers and Kiosks

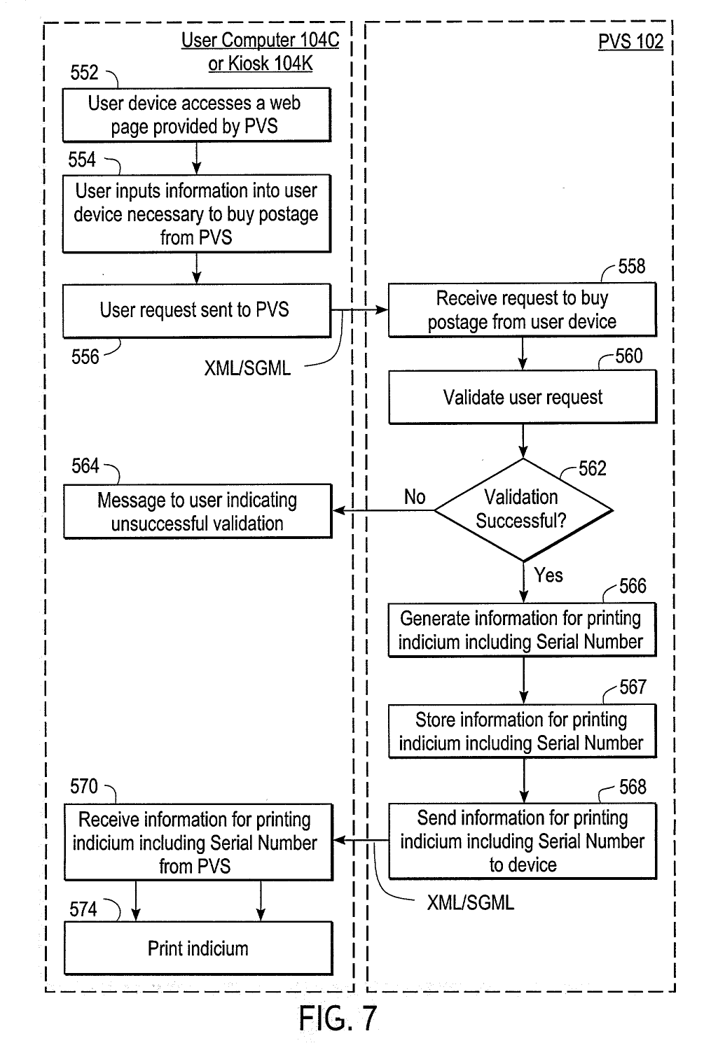

FIG. 7 is a flowchart showing processing performed by a user computer 104C or kiosk 104G on one hand and PVS 102 on the other hand in connection with generating one or more indicia. Processing is generally initiated when a user (at a user computer or kiosk) accesses a web page provided by PVS 102 (step 552). Using the web page(s), the user may then configure a request to buy postage from PVS 102 (step 554). For example, the user may request purchase of one or more $0.34 stamps. The user request to purchase postage may include user and payment information used by PVS 102 to bill for the purchased postage, the amount and value/denomination of the postage that the user wishes to purchase, and other like information that may be used by PVS 102 to process the request.

The user device then sends the user's request to purchase postage to PVS 102 via communications network 108 (step 556). A secure socket layer (SSL) connection may be established between kiosk 104 and PVS 102 to facilitate communication of information between user system 104 and PVS 102. The postage request may be sent using the eXenstible Markup Language (XML), Standard Generalized Markup Language (SGML), HTML, or a combination of one or more of HTML, SGML, or XML. SGML is a language for describing languages, i.e., a meta-language. XML is a subset of SGML.

PVS 102 then receives the user request to purchase postage from the user device (step 558). PVS 102 may then validate the user request (step 560). For example, PVS 102 may determine if the credit-card information provided by the user is valid. PVS 102 may use services provided by companies such as Cybercash and Cybersource to perform the credit-card information validation. If the request is from a registered user who has a pre-funded account, PVS 102 may determine if the user has sufficient funds in the user's account maintained by PVS 102 to satisfy the postage request. Alternatively, PVS 102 may determine if the credit-card information for the registered user is stored by PVS 102 or provided to PVS 102 by the user request. PVS 102 may also validate other information such as the identity of the user requesting the purchase, the type of postage requested by the user, and the like. If the validation process fails for any reason (branch step 562), the user's request may be terminated and a message may be communicated to the user indicating that validation of the user request was not successful (step 564). A reason why the validation failed may also be provided.

If validation is successful, PVS 102 then generates information for printing an indicium for each stamp requested in the user postage request (step 566). According to an embodiment of the present invention, the information for printing the indicium generated by PVS 102 is along the lines specified in the IBIP specifications published by the USPS, with the above-mentioned exception that the indicium does not contain a digital signature or other cryptographic identifier. As a tool for later verification of indicia in the field, the information includes a unique serial number as discussed above.

For each indicium, the information for printing the indicium (including the serial number) may include a bitmap of the indicium, a graphical image of the indicium, data representing the indicium, raw data corresponding to the indicium, or other information which facilitates printing of the indicium. The information for printing the indicium in a markup language format, e.g., XML format, is then sent from PVS 102 to the requesting the kiosk via communications network 108 (step 568).

The requesting user device then receives the information for printing the indicium (or indicia, each with a unique serial number) from PVS 102 (step 570). The information received in step 570 may then be used to print the indicium (step 574). A printer device (part of the kiosk or associated with the user computer) is used to print the indicium (or indicia). The code used in printing the indicium (or indicia) according to step 574 may include, for example, OCX, a Java applet, a VBScript, a Java Script, ActiveX controls, a C++ program, a C program, a Java program, etc. Additional details of the nature of the requests and responses, and the validation performed by PVS 102 can be found in the above-referenced U.S. patent application Ser. No. 09/902,480.

Indicium Generation for Meters

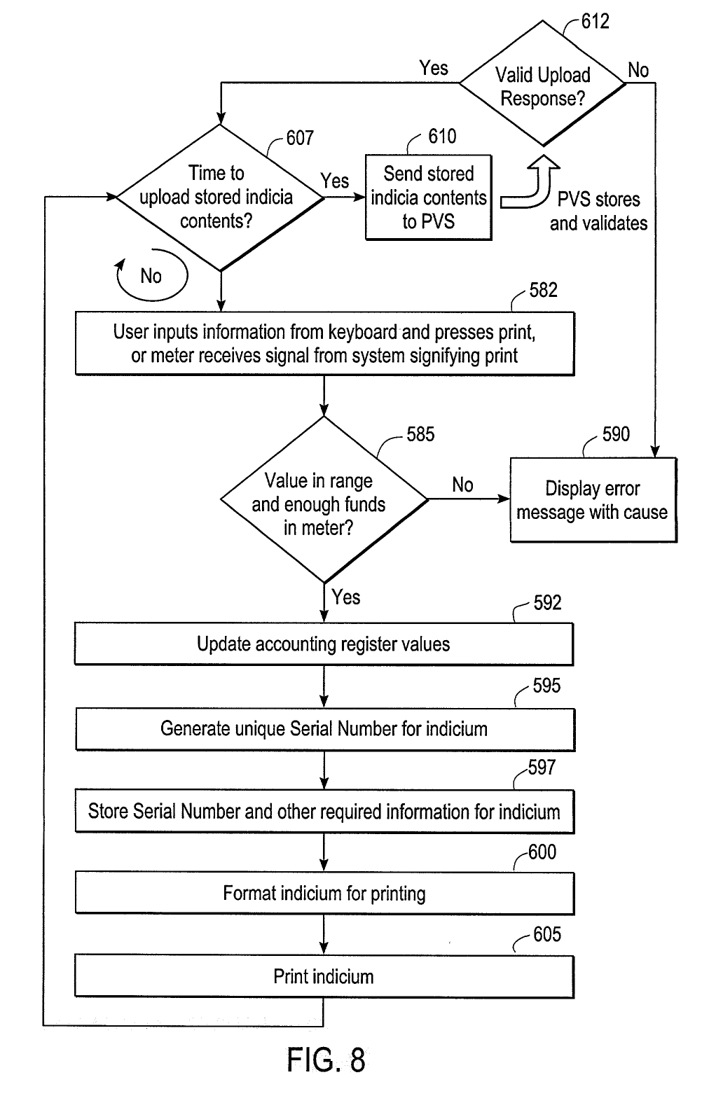

FIG. 8 is a flow chart showing processing performed by a meter 104M in connection with generating one or more indicia. For purposes of this discussion, the meter can be generating and printing an indicium, responding to a condition under which the meter is required to initiate a connection with PVS 102 to upload previously generated indicium contents, or waiting in a loop. Processing is generally initiated when a user of the meter presses a print key on the keyboard, or when other components in a mailing system signal the meter to create an indicium (step 582). The meter then checks the user request (step 585) to determine whether the requested amount of postage is in the range of permissible postage values and whether the meter registers contain enough postal value. If the validation process fails for any reason, a message is displayed (step 590), indicating that validation of the user request was not granted and preferably also the reason.

If validation is successful, the meter commences the necessary processing to generate the indicium. This entails updating the meter's accounting registers (step 592) to reflect the amount of the indicium to be printed. The meter then generates a unique serial number for the indicium (step 595) and assembles any other required information for the indicium. The serial number and other required information are stored (step 597) in non-volatile record storage 350. The meter then formats the indicium information for printing the machine-readable and human readable portions of the stamp (step 600) and printer 265 prints the indicium (step 605).

The meter then determines (branch step 607) whether it is required to send the stored indicium contents to PVS 102. This would be the case if a predetermined time, say 24 hours, had elapsed since the last communication with the PVS, or if a predetermined number of indicia had been printed since the last communication with the PVS. The need to send the stored indicia to the PVS arises from the need to be able to verify indicia, as will be described below. The need to limit the number of indicia reflects the size of record storage 350. If one of these conditions is met, the meter engages in an upload transaction with PVS 102 (step 610). If not, the meter enters the wait state until it is requested to print an indicium or a sufficient time elapses to necessitate a further contact with the PVS.

The indicia upload transaction can take various forms, but one implementation has the meter engage in a transaction akin to an IBIP device audit transaction. Under the IBIP specifications, a PSD has a watchdog timer that inhibits further indicia generation after a predetermined time interval has elapsed without a successful audit transaction. The PSD creates a message that contains the relevant meter and accounting information, digitally signs the message, and sends it to the PVS. The PVS assesses the continued integrity of the PSD's register values and other associated data, and if all is in order, responds with a digitally signed device audit response message which results in the resetting of the PSD's watchdog timer.

Thus, the analogous upload transaction would have the meter, as part of step 610, create a digitally signed message containing the serial numbers and other required information for the stored records, and send the message to PVS 102. The PVS has the infrastructure to verify the signature, and if the records are in order, store them in database 508, and send a digitally signed upload response message to the meter. The meter, on successfully verifying the signature (step 612), would then be allowed to pass through branch step 607 and wait for a signal to print further indicia. If the upload transaction fails, the meter would display an error message to that effect (step 590).

Indicium Verification

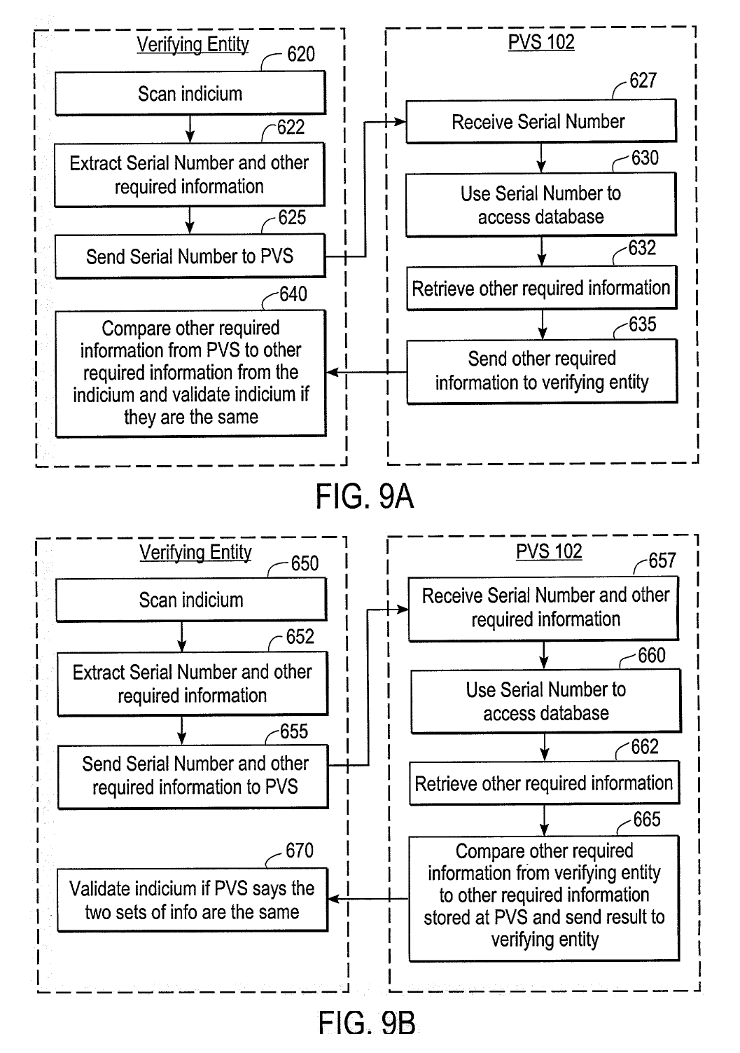

FIGS. 9A and 9B are flowcharts showing two variants of a process of an entity in the field verifying an indicium. In both variants, the verifying entity, which might be the postal vendor or the postal authority ultimately validates the indicium if the serial number and other required information from the indicium are the same as the serial number and other required information stored in database 508. The two variants differ with respect to the information that is sent back and forth and the particular entity performing the comparison of the information.

The first variant of FIG. 9A begins with the verifying entity scanning the indicium (step 620), extracting the serial number and other required information (step 622), and sending the serial number to PVS 102 (step 625). If desired, other information can be sent (information that is not “other required information” or even some or all of the “other required information”).

The PVS receives the serial number (step 627), and uses the serial number to access database 508 (step 630) and retrieve the other required information from the database record corresponding to that serial number (step 632). The PVS then sends the other required information to the verifying entity (step 635), and optionally logs information regarding the verification request. The verifying entity receives the other required information from the PVS, compares the other required information from the PVS to the other required information it had previously extracted from the indicium, and validates the indicium if the two are the same (step 640).

The second variant of FIG. 9B also begins with the verifying entity scanning the indicium (step 650) and extracting the serial number and other required information (step 622). The verifying entity then sends the serial number and other required information to PVS 102 (step 655). If desired, other information can also be sent.

The PVS receives the serial number and other required information (step 657), and uses the serial number to access database 508 (step 660) and retrieve the other required information from the database record corresponding to that serial number (step 662). The PVS then compares the required information from the database to the other required information it had received from the verifying entity, and sends the result of the comparison to the verifying entity (step 665). The PVS optionally logs information regarding the verification request. The verifying entity receives the result of the comparison from the PVS, and validates the indicium if the PVS message indicates that the two sets of other required information are the same (step 670).

The exchange of messages between the verifying entity and the PVS can be digitally signed for added security, especially if the transmission is not over a secure medium. In any event, the message from the PVS is an indication that the indicium had been generated by an authorized PSD or PSD resource and that the postage had been paid for. The digital signatures would provide each party to the verification transaction assurance that the other party was who it purported to be. Further, for electronic indicia, the counterpart to scanning the indicium would be parsing the message to find the indicium and its contents.

Conclusion

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware or only in software or using combinations thereof. For example, while the preferred implementation of the kiosk uses a touch screen for input, a separate keypad along the lines of ATMs could be used.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims. Therefore, the above description should not be taken as limiting the scope of the invention as defined by the claims.

What is claimed is:

1. A method for generating a value indicium, the method comprising:
sending, from a first location to a second location, a request for purchase of a value indicium, the request including at least a first set of information;
at the second location,
assigning a unique serial number to the requested indicium,
storing the first set of information and the assigned serial number, and
sending at least the serial number to the first location; and
incorporating the serial number and the first set of information into a format suitable for an indicium, the format being devoid of a cryptographic identifier.

2. The method of claim 1 further comprising, at the first location, printing the indicium on a substrate.

3. The method of claim 1 further comprising:
at the first location, combining the indicium with a payload message; and
sending the combined indicium and payload message to a third location.

4. The method of claim 1 wherein incorporating the serial number and the first set of information into a format suitable for an indicium occurs at the first location.

5. The method of claim 1 wherein incorporating the serial number and the first set of information into a format suitable for an indicium occurs at the second location

6. The method of claim 1 wherein the serial number is stored in 64 bits.

7. The method of claim 1 wherein the response comprises a statement of a markup language selected from a group consisting of HTML, XML, or SGML.

8. The method of claim 1 wherein:
the first set of information includes mailpiece information; and
the request also includes payment information.

9. The method of claim 1 wherein the first set of information includes a postal class and a monetary amount.

10. The method of claim 1 wherein:
the first set of information includes a postal class and a weight; and
the method further comprises:
at the second location,
computing a postage amount,
storing the postage amount along with the serial number and the first set of information, and
sending the postage amount along with the serial number to the first location.

11. The method of claim 1 further comprising:
at the second location,
generating a second set of information,
storing the second set of information along with the serial number and the first set of information, and
sending the second set of information along with the serial number to the first location; and
incorporating the second set of information along with the serial number and the first set of information into the format.

12. The method of claim 11 wherein the second set of information includes an ascending register value associated with the second location.

13. The method of claim 11 wherein the second set of information includes an indication of the current date and time.

14. A method, performed by a closed system meter, for generating value indicia, the method comprising:
for each indicium,
updating at least one accounting register to account for a postage amount for that indicium,
assigning a unique serial number to that indicium,
assembling a set of information for that indicium including the unique serial number,
storing a record for that indicium, the record including the set of information, and
printing the indicium to include the set of information; and
after printing a plurality of indicia, sending the records for the plurality of indicia to location remote from the meter.

15. The method of claim 14 wherein the meter, after printing the plurality of indicia:
disables printing of further indicia;
awaits a confirmation from the location remote from the meter that the records were received and stored;
upon receipt of confirmation, enables printing of further indicia.

16. A method for verifying a value indicium that includes a serial number and other required information, the other required information being devoid of a cryptographic identifier, the method comprising:
at a first location,
determining at least the serial number from the indicium, and
sending a first message containing at least the serial number to a second location;
at the second location,
accessing a collection of stored indicium information, wherein each member of the collection includes a uniquely assigned serial number and the other required information for a previously generated indicium,
extracting the member of the collection corresponding to the serial number received from the first location, and
sending a cryptographically signed second message to the first location; and
at the first location,
testing, on the basis of the second message, whether the indicium is valid.

17. The method of claim 16 wherein:
the first message includes the serial number;
the second message includes all the other required information;
the indicium is tested for validity at the first location by:
cryptographically verifying the second message,
extracting the other required information from the message,
comparing the other required information from the second message with the other required information in the indicium, and
accepting the indicium as valid if and only if the cryptographic verification is successful and the other required information from the second message is identical to the other required information in the indicium.

18. The method of claim 16 wherein:
the first message includes the serial number and all the other required information;
the second message includes an indication of whether the other required information from the first message is identical to the other required information stored at the second location in association with the serial number;
the indicium is tested for validity at the first location by:
cryptographically verifying the second message,
testing the indication from the second message; and
accepting the indicium as valid if and only if the cryptographic verification is successful and the indication in the second message indicates that the other required information from the first message is identical to the other required information stored at the second location in association with the serial number.

19. The method of claim 16 wherein the collection of stored indicia information includes:
a first set of members where the unique serial numbers were stored substantially contemporaneously with being generated at the second location; and
a second set of members where the unique serial numbers were stored in batches at times following generation by meters located at remote locations with respect to said second location.

20. The method of claim 16 further comprising:
cryptographically signing the first message at the first location; and
cryptographically verifying the first message at the second location.

21. The method of claim 16 wherein:
the indicium is printed on a substrate; and
the serial number and other required information are determined by scanning the substrate.

22. The method of claim 16 wherein:
the indicium is incorporated as part of an electronic message; and
the serial number and other required information are determined by parsing the electronic message and extracting the indicium.

23. A method for obtaining postage by a consumer using a remote device over a communications network connected to a computer server, the method comprising:
the remote device accessing the computer server;
the remote device sending, from a first location to a second location, a request for purchase of a value indicium, the request including at least a first set of information;
the remote device receiving a unique serial number from the computer server; and
the remote device outputting an indicium that includes at least the serial number and at least a portion of the first set of information, the indicium being devoid of a cryptographic identifier.

24. A method for distributing postage to a consumer using a remote device over a communications network by a computer server, the method comprising:
the computer server receiving a request for purchase of a value indicium, the request including at least a first set of information;
the computer server assigning a unique serial number to the requested indicium;
the computer server storing the first set of information and the assigned serial number; and
the computer server sending at least the serial number to the remote device as part of a message that is devoid of a cryptographic identifier.

25. The method of claim 24 further comprising:
the computer server generating additional information;
the computer server storing the additional information along with the first set of information and the assigned serial number;
the computer server sending at least part of the additional information in the message that includes the serial number and is devoid of a cryptographic identifier.

26. A method for generating a value indicium, the method comprising:
sending, from a first location to a second location, a request for purchase of a value indicium, the request including at least a first set of information;
at the second location,
assigning a unique serial number to the requested indicium,
storing the assigned serial number and sufficient information in a database to allow subsequent verification of the indicium by accessing the database on the basis of the serial number;
sending at least the serial number to the first location;
incorporating the serial number and the first set of information into a format suitable for an indicium, the format being devoid of a cryptographic identifier.

27. The method of claim 26 wherein incorporating the serial number and the first set of information into a format suitable for an indicium occurs at the first location.

28. The method of claim 26 wherein incorporating the serial number and the first set of information into a format suitable for an indicium occurs at the second location
